(19) United States
(12) Patent Application Publication
(10) Pub. No.: US 2014/0210604 A1
(43) Pub. Date: Jul. 31, 2014

(54) CONTROL SYSTEM FOR CONTROLLING DISPLAY DEVICE

(71) Applicant: DENSO CORPORATION, Kariya-city (JP)

(72) Inventors: Takeshi Kawashima, Nisshin-city (JP); Hiroya Takikawa, Kariya-city (JP); Shingo Shibata, Chiryu-city (JP)

(73) Assignee: DENSO CORPORATION, Kariya-city (JP)

(21) Appl. No.: 14/167,103

(22) Filed: Jan. 29, 2014

(30) Foreign Application Priority Data
Jan. 30, 2013 (JP) 2013-015947

(51) Int. Cl. B60R 16/023

(52) U.S. Cl. CPC B60R 16/0232
USPC 340/439; 340/438; 340/456; 340/458

(57) ABSTRACT

A control system for controlling a display device mounted on a vehicle includes: a first control device for controlling the display device to display a first information image corresponding to a specific event when the specific event occurs; and a second control device for controlling the display device to display a second information image corresponding to the specific event after the display device displays the first information image. The second control device changes a display start time of the second information image according to at least one of a driving condition of the vehicle and a driver condition of a driver of the vehicle.

### CROSS REFERENCE TO RELATED APPLICATION

This application is based on Japanese Patent Application No. 2013-15947 filed on Jan. 30, 2013, the disclosure of which is incorporated herein by reference.

### TECHNICAL FIELD

The present disclosure relates to a control system for controlling a display device.

### BACKGROUND

Conventionally, a control system controls a display device disposed on an instrument panel of a vehicle so that the display device displays navigation information, traffic information, air-conditioning information, audio information, mail information, and telephone information.

For example, the control system controls the display device to execute pushed-type delivered message of the above information on a display screen. Here, the pushed-type delivered message is information display, which is presented to an user such as a driver of a vehicle when an instruction other than an user instruction is generated as an activation trigger. Further, “message” includes not only a general character-base message but also other display manner such as a symbolic message. In the control system according to JP-A-2006-38740, the pushed-type delivered message of the information is prohibited until a certain condition is met after a destination is set.

It is difficult for a driver of a vehicle to watch the display device for a long time when the driver drives the vehicle. Thus, the present inventors consider transmitting a series of information items relating to specific topics to the driver so as to understand the information easily and quickly by displaying multiple information images in a stepwise manner.

However, it is difficult for the driver, who has limited time to watch the display device, to convey the information at certain display timing so as to understand the information easily even when multiple information images are displayed in a stepwise manner.

### SUMMARY

It is an object of the present disclosure to provide a control system for controlling a display device to display multiple information images in a stepwise manner at appropriate intervals.

According to an aspect of the present disclosure, a control system for controlling a display device mounted on a vehicle includes: a first control device for controlling the display device to display a first information image corresponding to a specific event when the specific event occurs; and a second control device for controlling the display device to display a second information image corresponding to the specific event after the display device displays the first information image. The second control device changes a display start time of the second information image according to at least one of a driving condition of the vehicle and a driver condition of a driver of the vehicle.

The above system controls the display device to display the second information image at appropriate timing according to a situation.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a vehicular system;

FIG. 2 is a diagram showing multiple display regions on the display device;

FIG. 3 is a diagram showing a first information image and a second information image on a display screen according to a first example;

FIG. 4 is a flowchart showing a display control process executed by a CPU of the display control device;

FIG. 5 is a diagram showing a first information image and a second information image on a display screen according to a second example;

FIG. 6 is a diagram showing a first information image and a second information image on a display screen according to a third example;

FIG. 7 is a diagram showing a first information image and a second information image on a display screen according to a fourth example;

FIG. 8 is a diagram showing a first information image and a second information image on a display screen according to a fifth example;

FIG. 9 is a flowchart showing a time adjustment process executed by the CPU of the display control device;

FIG. 10 is a flowchart showing a time adjustment process according to a first modification; and

FIG. 11 is a flowchart showing a time adjustment process according to a second modification.

### DETAILED DESCRIPTION

An embodiment of the present disclosure will be explained with reference to the drawings.

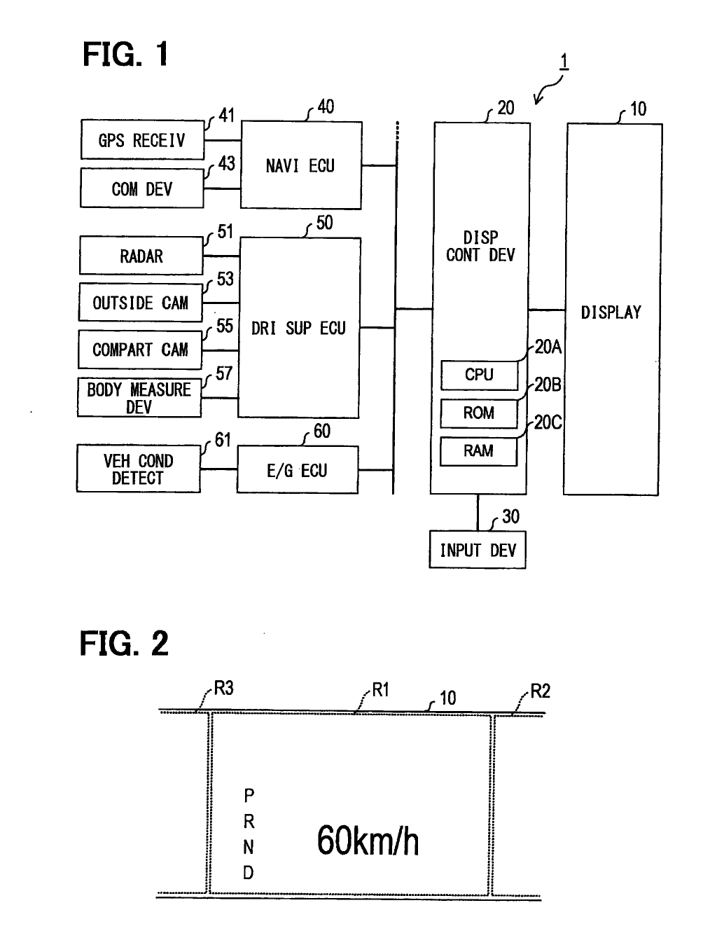

A vehicular system 1 according to an example embodiment includes a display device 10, a display control device 20, an input device 30 and multiple electric control units (i.e., ECUs) 40, 50, 60, as shown in FIG. 1.

The display device 10 is made from a liquid crystal display having a display screen for displaying various information thereon. The display device 10 is controlled by the display control device 20 so that the display device 10 displays various information on a display screen (e.g., a liquid crystal display screen). Specifically, the display device 10 is arranged on a front side of a driver seat in a compartment of the vehicle. Thus, the display device 10 displays information for the driver as a passenger of the vehicle.

The display control device 20 is communicated with and connected to multiple electric control units 40, 50, 60 via an in-vehicle network. The display control device 20 controls the display device 10 so that the display 10 displays information images, which are obtained based on information from the ECUs 40, 50, 60. Thus, various information is provided to the driver via the display device 10 by executing the display control process.

Specifically, the display control device 20 includes a CPU 20A, a ROM 20B and a RAM 20C. The CPU 20A executes a process according to a program. The ROM 20B is a non-volatile memory such as a flash memory for re-writing data electrically. The RAM 20C provides a working area when the CPU 20A executes the process. Thus, the display control device 20 executes the display control for the display device 10 by performing the process with the CPU 20A according to the program stored in the ROM 20B.

The input device 30 receives an operation from a vehicle passenger such as the driver, so that the input device 30 inputs the operation signal into the display control device 20. For example, the input device 30 includes a mechanical key (i.e., mechanical switch) on a steering wheel as a handle of the vehicle. The input device 30 inputs the operation signal of the key into the display control device 20. Alternatively, the input device 30 may include a remote controller or a touch panel.

Further, the input device 30 functions as a voice message recognition device for recognizing a voice message, which is output by the vehicle passenger, based on an input signal from a microphone. Further, the input device 30 inputs the recognized voice message as recognized vocabulary into the display control device 20. Alternatively, the input device 30 may include multiple different types of devices, which are described here.

In the display control device 20, multiple electric control units 40, 50, 60 include a navigation ECU 40, a drive support ECU 50 and an engine ECU 60, each of which is communicated with and connected to the display control device 20.

The navigation ECU 40 executes a process for providing a map display function, a route guide function and the like. The navigation ECU 40 is connected to a GPS receiver 41. The GPS receiver 41 detects a current position based on a satellite electric wave from a GPS satellite. The GPS receiver 41 inputs detected current position information into the navigation ECU 40.

The navigation ECU 40 is further connected to communication devices 43 as a group of communication devices 43 for obtaining various information from an external device. The communication devices 43 includes a communication device, which executes data communication and voice communication with the external device via a wireless communication network such as cellar network and a Wi-Fi (registered trademark) network. Further, the navigation ECU 40 is connected to the communication devices such as a VICS (registered trademark) receiver for receiving traffic information transmitted from a roadside device and a receiver for receiving traffic information broadcasted from a broadcast station. Thus, the navigation ECU 40 is connected to a communication device, which communicates with a mobile terminal such as a smart cell phone brought in a compartment of the vehicle via a short range wireless communication method.

The navigation ECU 40 executes a process for realizing the map display function and the route guide function based on the current position information obtained from the GPS receiver 41 and the traffic information obtained via the communication devices 43.

For example, the navigation ECU 40 generates the map image around the current position of the vehicle and the route guide image from the current position to the destination. The ECU 40 inputs the images to the display control device 20. The display control device 20 controls the display 10 to display information images such as the map image and the route guide image according to the input information.

Further, the navigation ECU 40 notifies the display control device 20 of information of occurrence of a traffic jam when the ECU 40 receives the traffic information that represents the occurrence of the traffic jam on a guide route around the current position or the destination. Thus, the ECU 40 in cooperation with the display control device 20 controls the display device 10 to display the information image about the traffic jam.

Further, the navigation ECU 40 has a transmitting/receiving function for an e-mail via the communication devices 43. Specifically, the navigation ECU 40 communicates with an external mail server or a mobile terminal such as a cell phone brought in the compartment, so that the ECU 40 receives the e-mail having a mail address, which corresponds to the driver and is preliminary registered.

The navigation ECU 40 transmits the information of the occurrence of the receipt of the e-mail to the display control device 20, and the navigation ECU 40 in cooperation with the display control device 20 controls the display device 10 to display the information image that notifies the receipt of the e-mail. The ECU 40 receives the operation signal input from the input device 30 via the display control device 20, and based on the operation signal, the ECU 40 opens the received e-mail and transmits another e-mail.

The navigation ECU 40 has a telephone function via the communication devices 43. Thus, the ECU 40 notifies the information of occurrence of the in-coming call when one of the communication devices 43 having the cellar communication function or the mobile terminal brought in the compartment receives the in-coming call. Then, the ECU 40 in cooperation with the display control device 20 controls the display device 10 to display the information image that notifies the in-coming call. Further, the ECU 40 responds to the in-coming call and sends a call to the external telephone according to the operation signal from the input device 30.

The drive support ECU 50 executes a process for supporting the driver to drive the vehicle. The drive support ECU 50 is connected to a radar device 51, an outside camera 53, a compartment camera 55 and body measurement devices 57.

The radar device 51 emits a radar wave to surroundings of the vehicle including a front periphery, and the radar device 51 receives a reflection wave of the radar wave. Thus, the radar device 51 detects a relative position and a relative speed of an object such as another vehicle, a pedestrian, and a guardrail, which is disposed around the vehicle, with respect to the vehicle. The radar device 51 inputs the vehicle peripheral information to the drive support ECU 50. The vehicle peripheral information includes the information of the relative position and the relative speed of the object disposed around the vehicle.

The outside camera 53 shoots a periphery of the vehicle including the front periphery, so that the camera 53 sends shot image data to the drive support ECU 50. Here, the shot image data includes not only data about a static image but also data about a moving image. The compartment camera 55 shoots the driver of the vehicle, so that the camera 55 sends shot image date to the drive support ECU 50.

The body measurement devices 57 are a group of devices for measuring a body signal (i.e., body condition signal) of the driver. The body measurement devices 57 include a sensor for detecting electrocardiographic wave of the driver, a sensor for detecting a muscle potential of the driver, a sensor for detecting a pulse of the driver, a sensor for measuring a blood pressure of the driver, and other sensors for measuring a body condition of the driver, each of which presents a body signal of the driver. These measurement data are input into the drive support ECU 50.

The drive support ECU 50 executes the process for supporting the drive of the vehicle by the driver based on the input signals from the radar device 51, the outside camera 53, the compartment camera 55 and the body measurement devices 57.

For example, the drive support ECU 50 detects an approaching object, which has a possibility of collision with the vehicle, based on the vehicle peripheral information input from the radar device 51. When the ECU 50 detects the approaching object having the possibility of collision, the ECU 50 sends the information about the approaching object to the display control device 20, so that the ECU 50 in cooperation with the display control device 20 controls the display device 10 to display the information image including the shot image of the outside camera 53, which shows the approaching object.

Further, the drive support ECU 50 in cooperation with the engine ECU 60, a steering ECU (not shown), a brake ECU and the like execute a vehicle control for avoiding the collision with the object when the possibility of collision becomes equal to or higher than a certain level. Here, the steering ECU is an electric control unit for executing a steering control. The brake ECU is an electric control unit for executing a brake control.

The drive support ECU 50 executes a process for inputting information such as vehicle periphery information obtained from the radar device 51, shot image data obtained from the outside camera 53 and the compartment camera 55, and the body measurement data obtained from the body measurement devices 57 into the display control device 20 via the in-vehicle network.

Further, the engine ECU 60 is an electric control unit for executing an engine control. The engine ECU 60 is connected to vehicle condition detection devices 61.

The vehicle condition detection devices 61 provide a group of vehicle condition detection devices 61 for detecting the vehicle conditions. The vehicle condition detection devices 61 includes devices for detecting a running speed of the vehicle, an engine rotation speed, a water temperature, a battery voltage, a fuel amount, a state of a blinker (i.e., turn indicator) such as an turn-on state and an turn-off state, a steering wheel operation amount (a steering angle) and a shift lever position. Each of the devices in the vehicle condition detection devices 61 transmits detection data to the engine ECU 60.

The engine ECU 60 executes the engine control based on the input data from the vehicle condition detection devices 61. Further, the engine ECU 60 transmits the detection data obtained from the vehicle condition detection devices 61 to the display control device 20 via the in-vehicle network.

Next, the detailed construction of the display device 10 and the display control device 20 will be explained with reference to FIGS. 2 to 9. In the present embodiment, the display surface of the display device 10 has a horizontally long shape. As shown in FIG. 2, the display surface has display regions R1, R2, R3 arranged in a horizontal direction. These display regions R1, R2, R3 have the same shape. In FIG. 2, only a part of the display regions R2, R3 is simplified and shown.

The display device 10 is controlled by the display control device 20 so that the display device 10 displays individual information in the display regions R1, R2, R3. For example, the device 10 displays the information image showing the running speed and the shift lever position of the vehicle in FIG. 2 in the display region R1, which is disposed at the center of the display regions R1-R3. The device 10 displays the information image showing the vehicle conditions such as the battery voltage and the water temperature in the display region R2, which is disposed on the right side of the display regions R1-R3. The device 10 displays the information image showing the map image and the route guide image in the display region R3, which is disposed on the left side of the display regions R1-R3.

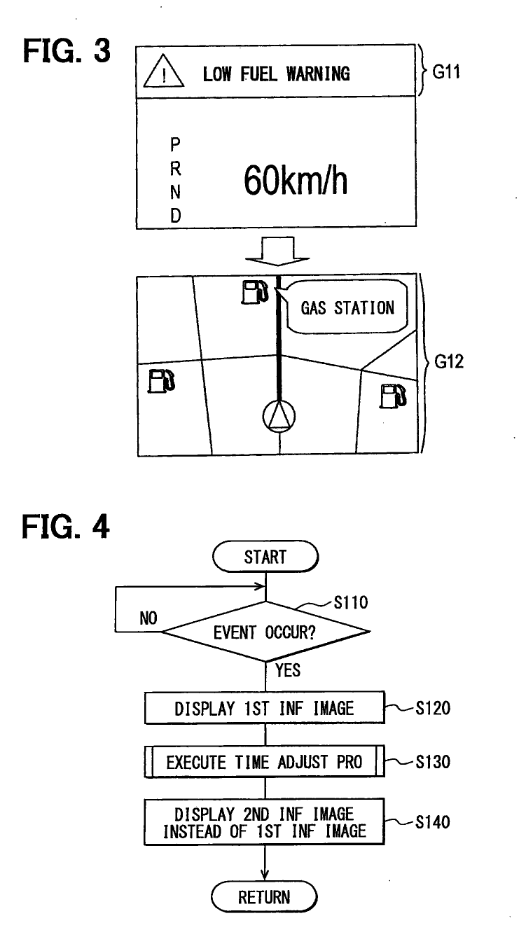

Further, the device 10 displays the information image showing an event, which occurs successively, in an upper part of the display region R1, so that the content of the event is noticed in pushed-type delivered manner without a request from the passenger of the vehicle. For example, the display device 10 is controlled by the display control device 20 so that the device 10 displays the information image G11 showing the low fuel warning that the fuel amount becomes small in the upper part of the display region R1 when the fuel amount is equal to or lower than a predetermined amount. Then, the display device 10 is controlled by the display control device 20 so that the device 10 displays the information image G12 including the route guide image to a nearest gas station in a whole of the display region R1, as shown in a lower part of FIG. 3.

Here, when it is necessary to display the running speed of the vehicle always because of the law or the like, the running speed of the vehicle may be displayed in the display region R2, R3 other than the display region R1 in a case where the information image G12 shown in a lower part of FIG. 3 is displayed in the display region R1. Alternatively, the information image G12 shown in a lower part of FIG. 3 may not be displayed in a whole of the display region R1 so that an area for displaying the running speed of the vehicle is secured in a lower part of the display region R1, for example.

Next, a process executed by the CPU 20A of the display control device 20 for displaying the information image corresponding to the event in the display region R1 in a pushed-type delivered message manner will be explained with reference to FIG. 4. The CPU 20A executes the display control process shown in FIG. 4 repeatedly according to a program stored in the ROM 20B.

When the CPU 20A starts to execute the display control process in FIG. 4, the CPU 20A waits for occurrence of an event among predetermined events at step S110. When one of the events occurs, i.e., when the determination of step S110 is “YES,” at step S120, the CPU 20A controls the display device 10 so that the device 10 displays the first information image corresponding to the one of events.

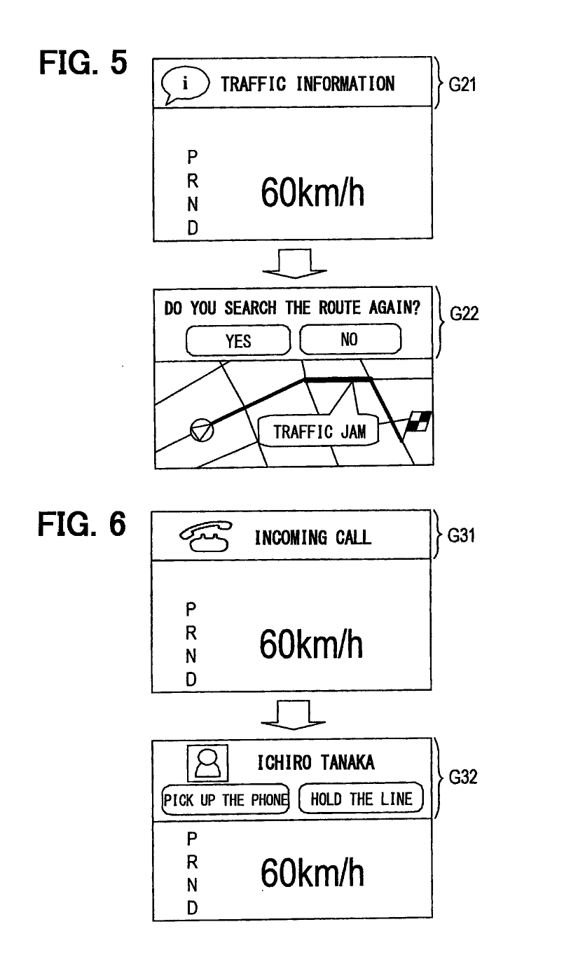

For example, the CPU 20A transfers from step S110 to step S120 when the navigation ECU 40 notifies the occurrence of the event such as traffic jam. At step S120, the CPU 20A controls the display device 10 to display the simplified information image G21 as the first information image in the upper part of the display region R1, as shown in an upper part of FIG. 5. The simplified information image G21 relates to the traffic jam event and shows a message of “traffic jam information” for notifying the occurrence of the traffic jam to the driver.

Similarly, the CPU 20A transfers from step S110 to step S120 when the navigation ECU 40 notifies the occurrence of the in-coming call. At step S120, as shown in the upper part of FIG. 6, the CPU 20A controls the display device 10 to display the simplified information image G31 as the first information image in the upper part of the display region R1. The simplified information image G31 relates to the in-coming call event and shows a message of “the in-coming call” for notifying the in-coming call to the driver.

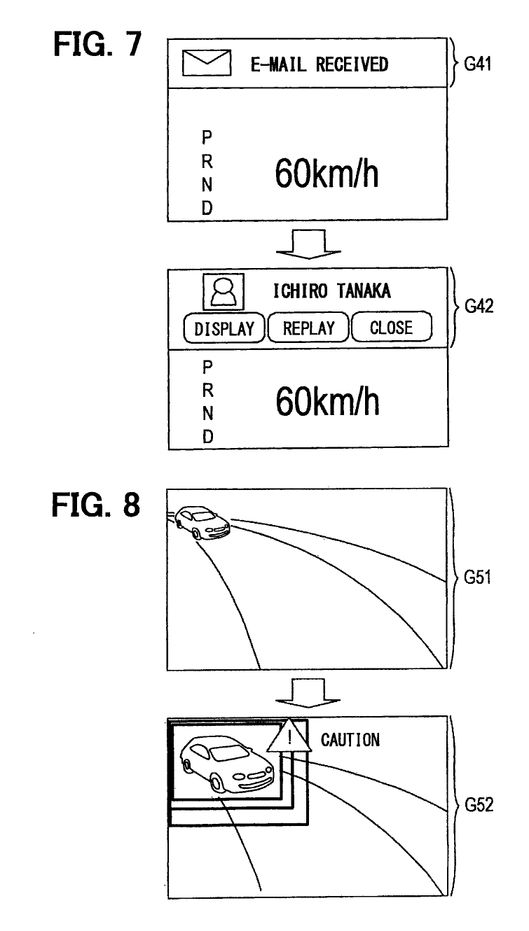

The CPU 20A transfers from step S110 to step S120 when the navigation ECU 40 notifies the occurrence of the receiving event of the e-mail. At step S120, as shown in the upper part of FIG. 7, the CPU 20A controls the display device 10 to display the simplified information image G41 as the first information image in the upper part of the display region R1. The simplified information image G41 relates to the receiving event and shows a message of “the receiving of the e-mail” for notifying the receiving of the e-mail to the driver.

The CPU 20A transfers from step S110 to step S120 when the drive support ECU 50 notifies the occurrence of the approaching object event. At step S120, as shown in the upper part of FIG. 8, the CPU 20A controls the display device 10 to display the information image G51 as the first information image in a whole of the display region R1. The information image G51 relates to the approaching object event and includes a shooting image of the outside camera 53, which shows the approaching object. Here, the shooting image includes not only a static image but also a moving image.

The CPU 20A transfers from step S110 to step S120 when the engine ECU 60 notifies the low fuel warning such that the fuel amount is equal to or lower than the predetermined amount. At step S120, the CPU 20A controls the display device 10 to display the information image G11 in the upper part of FIG. 3 as the first information image in the upper part of the display region R1.

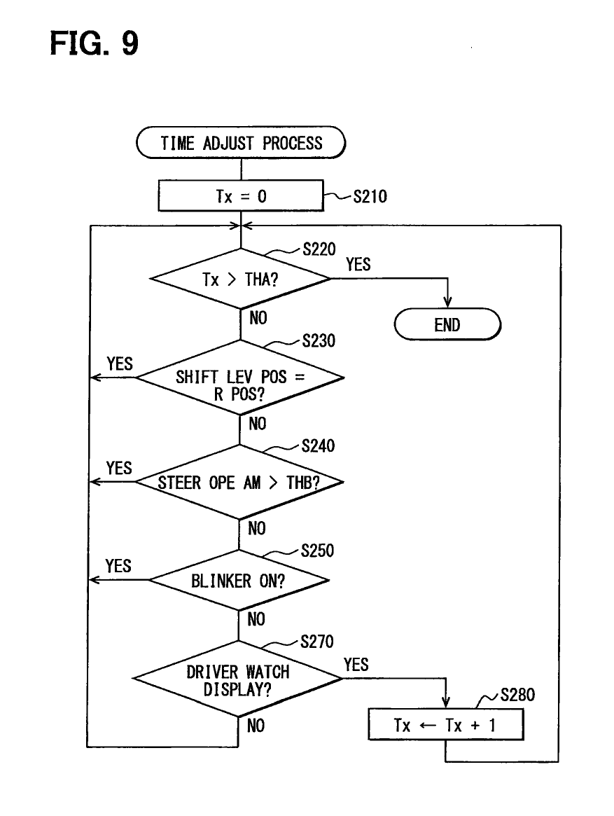

When step S120 ends, the CPU 20A starts to execute the time adjustment process in FIG. 9, so that the CPU 20A stands by for a predetermined time interval corresponding to the situation at step S130. Then, it goes to step S140, as shown in FIG. 4. At step S140, the CPU 20A controls the display device 10 to display the second information image corresponding to the occurred event in the display region R1 instead of the first information image displayed in step S120.

The second information image displayed in the display region R1 relates to at least one of a notice image of the occurred event, an inquiry image, a detailed information image, and an emphasized image.

The notice image is an information image for notifying a handling proposal to the occurred event. The inquiry image is an information image for inquiring handling strategy of the occurred event. The detailed information image is an information image for showing the detailed information corresponding to the simplified information displayed as the first information image. The emphasized image is an information image for emphasizing and showing specific information displayed as the first information image.

For example, when the traffic jam event occurs, the CPU 20A controls the display device 10 at step S140 to display the information image G22 as the second information image in the display region R1, as shown in the lower part of FIG. 5. The information image G22 provides the detailed information image relating to the traffic jam and the notice image for notifying the handling proposal for the traffic jam.

The information image G22 is an information image for showing the guide route to the destination and the traffic jam section, which are overlapped on the road map image. Further, the information image G22 notifies the proposal for searching the guide route to the destination again and inquires whether the search of the route again is executed.

When the guide route to the destination is not set, or when there is no traffic jam section on the guide route to the destination, the CPU 20A controls the display device 10 to display the detailed information image as the second information image corresponding to the traffic jam event. The detailed information image shows the traffic jam section over the map image around the current position of the vehicle.

The CPU 20A moves to step S110 when the CPU 20A completes the display of the second information image at step S140. Here, in addition to the display control process, the CPU 20A executes a reception process of an operation with respect to the operation object on the second information image, the operation being input by the driver via the input device 30. Then, the CPU 20A executes a process corresponding to the operation input via the input device 30. For example, at step S140, assuming that the information image G22 shown in the lower part of FIG. 5 is displayed on the display device 10. In this case, the CPU 20A in cooperation with the navigation ECU 40 searches the guide route to the destination again, which avoids the traffic jam section, when the “YES” button as the operation object is pushed down. When the “NO” button as the operation object is pushed down, the CPU 20A executes a step for closing the information image G22.

The CPU 20A controls the display device 10 to display the information image G32 as the second information image in the display region R1 at step S140 when the in-coming call event occurs, as shown in the lower part of FIG. 6. The information image G32 provides the inquiry image relating to the in-coming call.

The information image G32 is an information image for inquiring whether a method for switching to a communication mode is selected as the handling strategy with respect to the in-coming call event or a method for switching to a holding mode is selected as the handling strategy. The information image includes an operation object for inputting an operation to switch to the communication mode and an operation object for inputting an operation to switch to the holding mode. The information image G32 also provides the detailed information image relating to the in-coming call event since the image G32 shows the name of the opponent of the in-coming call.

The CPU 20A controls the display device 10 to display the information image G42 as the second information image in the display region R1 at step S140 when the reception event of the e-mail occurs, as shown in the lower part of FIG. 7. The information image G42 provides the inquiry image relating to the reception event.

The information image G42 includes an inquiry for opening the e-mail, an operation object for inputting an operation to open the e-mail and display the content of the e-mail in a text display manner so as to inquiring an output method of the opened e-mail, an operation object for inputting an operation to open the e-mail and replay or read the content of the e-mail, and an operation object for inputting an operation to suspending to open the e-mail.

The CPU 20A controls the display device 10 to display the information image G52 as the second information image in the display region R1 at step S140 when the approaching object event occurs, as shown in the lower part of FIG. 8. The information image G52 provides the emphasized image for emphasizing and displaying the approaching object, which is displayed in the first information image. The information image G52 is an information image (i.e., an emphasizing image) for emphasizing the approaching object shown in the shot image of the outside camera 53 by surrounding the approaching object with a frame and for displaying a figure and/or a character, which calls for attention.

When the approaching object event occurs such that the approaching object having a possibility of collision with the vehicle appears, the first information image displayed at step S120 is the information image G51 including the shot image of the approaching object. At step S140, the display device 10 displays the information image G52 as the second information image such that the shot image of the approaching object is processed in order to emphasize the approaching object.

After the display device 10 displays the information image G11 shown in the lower part of FIG. 3 as the first information image, the CPU 20A controls the display device 10 at step S140 to display the information image G12 as the second information image in a whole of the display region R1, the information image G12 is an notice image for notifying the handling strategy with respect to the low fuel warning and includes a route guide image to a nearest gas station. The information image G12 is displayed in the display region R1 until an operation for closing the information image G12 is input by the driver via the input device 30, for example.

In the present embodiment, every time when a specific event occurs, the display control device 20 controls the display device 10 to switch to display from the first information image to the second information image, which correspond to the event, in turn.

Then, the detail of the time adjustment process executed at step S130 will be explained with reference to FIG. 9. The CPU 20A executes the time adjustment process in FIG. 9 so that the time interval from the display start time of the first information image to the switching time between the first information image and the second information image, that defines the display start time of the second information image, is adjusted according to the driving condition of the vehicle and the driver condition.

For example, the CPU 20A adjusts the display start time of the second information image such that the display start time of the second information image is delayed when the driving condition of the vehicle is in a high load state that influences the high driving load of the driver, compared with a case where the driving condition of the vehicle is in a low load state. Further, the CPU 20A adjusts the display start time of the second information image according to time interval, for which the driver watches the display screen of the display device 10.

Specifically, when the CPU 20A starts to execute the time adjustment process in FIG. 9, the CPU 20A resets the visual contact time Tx of the driver to be zero at step S210. The visual contact time Tx is a parameter showing the time interval, for which the driver watches the display screen of the device 10.

Then, the CPU 20A determines whether the visual contact time Tx exceeds a predetermined time interval defined as the threshold THA. The threshold THA is set to be one second or a few seconds, for example.

When the CPU 20A determines that the visual contact time Tx does not exceed the threshold THA, i.e., when the determination at step S220 is “NO,” the CPU 20A moves to step S230. At step S230, the CPU 20A determines whether the shift lever position is a rear (i.e., R) position. When the CPU 20A determines that the shift lever position is a rear (i.e., R) position, i.e., when the determination at step S230 is “YES,” it goes to step S220 without updating the visual contact time Tx since the CPU 20A regards that the driver drives the vehicle in reverse, and the driving condition is in the high load condition so that the driving condition affects the high driving load to the driver.

When the CPU 20A determines that the shift lever position is not a rear (i.e., R) position, i.e., when the determination at step S230 is “NO,” it goes to step S240. At step S240, the CPU 20A determines whether the steering wheel operation amount (i.e., a steering angle) of the vehicle exceeds a predetermined amount (i.e., a threshold THB). When the CPU 20A determines that the steering wheel operation amount exceeds the threshold THB, i.e., when the determination at step S240 is “YES,” it goes to step S220 since the CPU 20A regards that the driver steers in a new direction, and therefore, the driving condition is in the high load condition so that the driving condition affects the high driving load to the driver.

When the CPU 20A determines that the steering wheel operation amount does not exceed the threshold THB, i.e., when the determination at step S240 is “NO,” it goes to step S250. At step S250, the CPU 20A determines whether the blinker of the vehicle turns on, i.e., the blinker is in the on state. When the CPU 20A determines that the blinker of the vehicle turns on, i.e., when the determination at step S250 is “YES,” it goes to step S220 since the CPU 20A regards that the vehicle turns right or left, and therefore, the driving condition is in the high load condition so that the driving condition affects the high driving load to the driver.

When the CPU 20A determines that the blinker of the vehicle does not turn on, i.e., when the determination at step S250 is “NO,” or the blinker is in the off state, it goes to step S270. At step S270, the CPU 20A determines whether the driver watches the display screen of the display device 10. The determination whether the driver watches the display screen (i.e., the driver visually contacts with the display screen) is performed by analyzing the shot image data obtained from the compartment camera 55. Thus, the CPU 20A detects a visual line of the driver based on the shot image data. When the visual line directs to the display screen, the CPU 20A determines that the driver visually contacts with the display screen. When the visual line does not direct to the display screen, the CPU 20A determines that the driver does not watch the display screen.

Alternatively, at step S270, the CPU 20A may determine whether the driver visually contacts with the display region R1 on the display screen. Alternatively, the step for detecting the visual line may be performed in the drive support ECU 50. In this case, the CPU 20A may obtain the visual line detection result from the drive support ECU 50.

When the CPU 20A determines that the driver watches the display screen of the display device 10, i.e., when the determination at step S270 is “YES,” it goes to step S280. At step S280, the CPU 20A executes a process for incrementing the visual contact time Tx by one. Then, it goes to step S220. When the CPU 20A determines that the driver does not watch the display screen of the display device 10, i.e., when the determination at step S270 is “NO,” it goes to step S220 without updating the visual contact time Tx.

The CPU 20A repeatedly executes a process for updating (i.e., incrementing) the visual contact time Tx by one until the visual contact time Tx exceeds the threshold THA, so that the CPU 20A measures the time interval, during which the driver watches the display screen, under a condition that the driving condition of the vehicle is in the low driving load state.

When the CPU 20A determines that the visual contact time Tx exceeds the threshold THA, i.e., when the determination at step S220 is “YES,” the CPU 20A ends the time adjustment process, and then, it goes to step S140. At step S140, the CPU 20A controls the display device 10 to display the second information image.

When the CPU 20A executes the display control process including the time adjustment process, the CPU 20A delays the display start time of the second information image in a case where the driving condition is in the high driving load state such as in the reverse driving state, compared with a case where the driver does not drive the vehicle in reverse.

Similarly, the CPU 20A delays the display start time of the second information image in a case where the driving condition is in the high driving load state such that the steering operation amount is equal to or larger than a certain threshold, compared with a case where the steering operation amount is smaller than the certain threshold. Similarly, the CPU 20A delays the display start time of the second information image in a case where the driving condition is in the high driving load state such that the driver turns on the blinker, compared with a case where the driver does not turn on the blinker.

When the driving condition is in the high driving load state so that the driver is in the high driving load condition, the driver should focus attention on the safety drive. Accordingly, it is difficult for the driver to watch the display device 10 for long and sufficient time. Further, even if the driver watches the display device 10, the driver would not much pay attention to the image on the display device 10 as long as the image relates to less important issues with respect to the safety drive.

Thus, in the present embodiment, the CPU 20A executes the display control process including the time adjustment process, so that the CPU 20A controls the display device 10 to display the second information image after the display device 10 starts to display the first information image under a condition that a total time of the driver watching the display screen of the display device 10 exceeds the threshold THA when the driving condition of the vehicle is not in the high driving load state.

When the CPU 20A adjusts the display start time of the second information image by the above method so that the display device 10 provides the information service to the driver so as to be easily understandable for the driver such that the information corresponding to the event is provided by a stepwise display manner on the display screen, the CPU 20A controls the display device 10 to display the second information image at appropriate timing according to the driving condition of the vehicle and the driver condition so that the effects of information service in a stepwise display manner is sufficiently achieved.

Accordingly, in the present embodiment, the vehicular system 1 provides excellent information service for the driver. Thus, the system 1 provides various information to the driver by a pushed-type delivered manner with securing the driving safety.

### First Modification

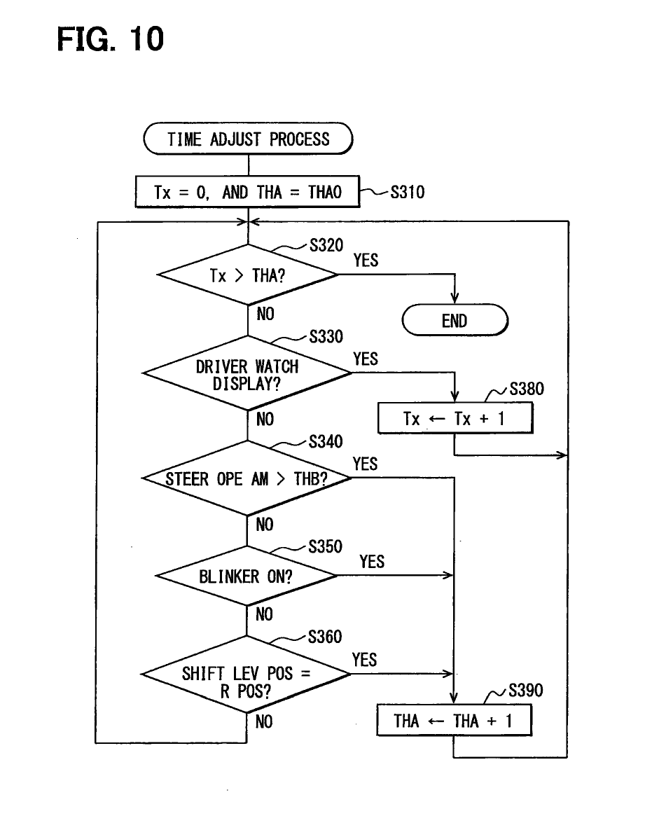

The display control device 20 may execute the time adjustment process shown in FIG. 10 instead of the time adjustment process in FIG. 9. The CPU 20A can adjust the display start time of the second information image appropriately according to the driving load in the time adjustment process in FIG. 10, similar to the time adjustment process in FIG. 9.

In the time adjustment process in FIG. 10, the CPU 20A resets the visual contact time Tx to be zero and sets the threshold THA to be an initial threshold THA0 at step S310. Then, at step S320, the CPU 20A determines whether the visual contact time Tx exceeds the threshold THA, similar to step S220.

When the CPU 20A determines that the visual contact time Tx does not exceed the threshold THA, i.e., when the determination at step S320 is “NO,” it goes to step S330. At step S330, similar to step S270, the CPU 20A determines whether the driver watches the display screen of the display device 10. When the CPU 20A determines that the driver watches the display screen, i.e., when the determination of step S330 is “YES,” the CPU 20A increments the visual contact time Tx by one at step S380, similar to step S280. Then, it goes to step S320.

When the CPU 20A determines that the driver does not watch the display screen of the display device 10, i.e., when the determination of step S330 is “NO,” it goes to step S340. At step S340, similar to step S240, the CPU 20A determines whether the steering operation amount exceeds the threshold THB. When the CPU 20A determines that the steering operation amount exceeds the threshold THB, i.e., when the determination of step S340 is “YES,” the CPU 20A increments the threshold THA, which is used for the determination at step S320, by one at step S390. Then, it goes to step S320.

When the CPU 20A determines that the steering operation amount is equal to or lower than the threshold THB, i.e., when the determination at step S340 is “NO,” the CPU 20A determines at step S350 whether the blinker turns on, similar to step S250. When the CPU 20A determines that the blinker turns on, i.e., when the determination at step S350 is “YES,” the CPU 20A increments the threshold THA by one at step S390. Then, it goes to step S320.

When the CPU 20A determines that the blinker is in the off state, i.e., when the determination of step S350 is “NO,” the CPU 20A determines at step S360 whether the shift lever position is the rear position, similar to step S230. When the CPU 20A determines that the shift lever position is the rear position, i.e., when the determination at step S360 is “YES,” the CPU 20A increments the threshold THA by one at step S390, and then, it goes to step S320.

When the CPU 20A determines that the shift lever position is not the rear position, i.e., when the determination at step S360 is “NO,” it goes to step S320 without updating the visual contact time Tx and the threshold THA. When the CPU 20A determines that the visual contact time Tx exceeds the threshold THA, i.e., when the determination at step S320 is “YES,” the CPU 20A ends the time adjustment process.

Thus, the time adjustment process according to the first modification is described above. In the first modification, the CPU 20A controls the display device 10 to display the second information image when the visual contact time Tx exceeds the threshold THA after the display device 10 starts to display the first information image. The CPU 20A adjusts or changes the threshold THA according to the driving condition of the vehicle. Specifically, the CPU 20A increases the threshold THA when the driving condition of the vehicle is in the high driving load state that affects the high driving load of the driver.

Accordingly, in the present modification, when the CPU 20A adjusts the display start time of the second information image by the above method so that the display device 10 provides the information service to the driver so as to be easily understandable for the driver such that the information corresponding to the event is provided by a stepwise display manner on the display screen, the CPU 20A controls the display device 10 to display the second information image at appropriate timing according to the driving condition of the vehicle and the driver condition so that the effects of information service in a stepwise display manner is sufficiently achieved.

### Second Modification

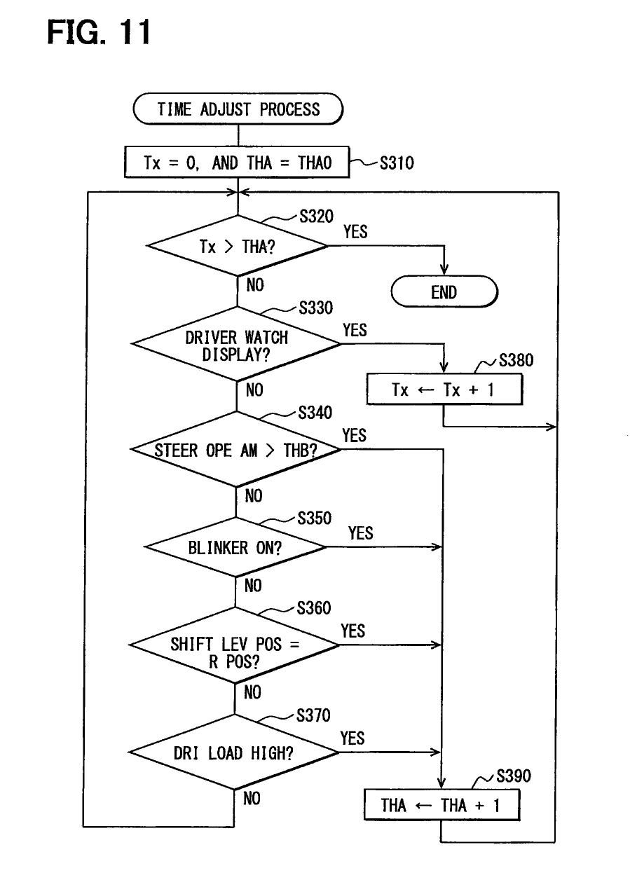

A time adjustment process according to a second modification will be explained. The CPU 20A of the display control device 20 may execute the time adjustment process shown in FIG. 11 instead of the time adjustment processes in FIGS. 9 and 10. The time adjustment process in FIG. 11 further includes step S370 compared with the time adjustment process in FIG. 10.

Specifically, in the time adjustment process according to the second modification, when the CPU 20A determines that the driver does not watch the display screen of the display device 10, i.e., when the determination in step S330 is “NO,” the CPU 20A executes steps after step S340, similar to the first modification. However, when the CPU 20A determines at step S360 that the shift lever position is not the rear position, i.e., when the determination at step S360 is “NO,” it goes to step S370.

At step S370, the CPU 20A determines the height of the driving load affecting the driver according to the measurement data regarding the body signal of the driver, which is obtained from the body measurement devices 57 via the drive support ECU 50. At step S370, for example, when the electrocardiographic data of the driver shows the high tension state higher than a normal state, the CPU 20A determines that the driving condition is in the high driving load state. When the electrocardiographic data of the driver shows the normal state or a low tension state, the CPU 20A determines that the driving condition is in the low driving load state. Alternatively, at step S370, when the pulse rate and/or the blood pressure of the driver exceed an upper limit of a normal state, the CPU 20A determines that the driving condition is in the high driving load state. When the pulse rate and/or the blood pressure of the driver do not exceed the upper limit of the normal state, the CPU 20A determines that the driving condition is in the low driving load state.

When the CPU 20A determines that the driving load is high, i.e., when the determination at step S370 is “YES,” the CPU 20A increments the threshold THA by one at step S390. Then, it goes to step S320. When the CPU 20A determines that the driving load is low, i.e., when the determination of step S370 is “NO,” it goes to step S320 without updating the visual contact time Tx and the threshold THA.

In the second modification, the body signal of the driver is measured, so that the driving load affecting the driver is determined. When the CPU 20A determines that the driving load is high, the CPU 20A delays the display start time of the second information image, compared with a case where the driving load is low. Thus, the CPU 20A changes the display start time of the second information image according to the driver condition. Accordingly, in the present modification, the CPU 20A controls the display device 10 to display the second information image at appropriate timing, which corresponds to the driver condition such as mental condition of a high tension state and/or an excited state.

### Other Modifications

In the above embodiments, the parameter showing the driving condition of the vehicle is the steering operation amount, the state of the blinker such as the on state and the off state, and the shift lever position, and, based on the parameter, the CPU 20A determines the driving load so that the CPU 20A adjusts the display start time of the second information image.

Alternatively, the parameter may be the brake operation amount, the acceleration pedal operation amount (i.e., acceleration opening degree), the driving speed of the vehicle, the acceleration rate and the like, and based on the parameter, the CPU 20A adjusts the display start time of the second information image. For example, when the driving speed is high, the CPU 20A regards that the driving load is high, and delays the display start time of the second information image, compared with a case where the driving speed is not high.

Alternatively, based on only the determination result of the driving load obtained from the measurement data via the body measurement devices 57 and the visual contact time Tx other than the driving condition of the vehicle, the CPU 20A may adjust the display start time of the second information image. For example, at step S330, when the determination of the CPU 20A is negative, the CPU 20A may skip steps S340 to S360, and it goes to step S370 directly.

The display control device 20 may execute one or two steps among steps S230 to S250 or S340 to S360 as a determination step relating to the driving condition of the vehicle, and skip other steps. Here, the skip of other steps means that the CPU 20A determines negatively. Alternatively, the CPU 20A may skip all steps from S230 to S250 or S340 to S370.

In the above embodiments, the first information image and the second information image are switched to display in the same display region R1. Alternatively, the display device 10 may display the second information image in the display region R2, R3 other than the display region R1. Alternatively, the display device 10 may add the second information image in the first region R1 in addition to the first information image without deleting or switching from the first information image.

Steps S110, S120 executed by the CPU 20A of the display control device 20 correspond to a first control device. Steps S130, S140 correspond to a second control device.

It is noted that a flowchart or the processing of the flowchart in the present application includes sections (also referred to as steps), each of which is represented, for instance, as S110. Further, each section can be divided into several sub-sections while several sections can be combined into a single section. Furthermore, each of thus configured sections can be also referred to as a device, module, or means.

The above disclosure has the following aspects.

According to an aspect of the present disclosure, a control system for controlling a display device mounted on a vehicle includes: a first control device for controlling the display device to display a first information image corresponding to a specific event when the specific event occurs; and a second control device for controlling the display device to display a second information image corresponding to the specific event after the display device displays the first information image. The second control device changes a display start time of the second information image according to at least one of a driving condition of the vehicle and a driver condition of a driver of the vehicle.

The above system controls the display device to display the second information image at appropriate timing according to a situation.

Alternatively, the second control device may delay the display start time of the second information image when the driving condition is in a high driving load state, compared with a case where the driving condition is not in the high driving load state. The high driving load state is preliminary set as a state that provides a high driving load to the driver. Further, the second control device may delay the display start time of the second information image when the driver drives the vehicle in reverse, compared with a case where the driver does not drive the vehicle in reverse. Further, the second control device may delay the display start time of the second information image when a steering operation amount of the vehicle is equal to or larger than a predetermined threshold amount, compared with a case where the steering operation amount of the vehicle is smaller than the predetermined threshold amount. Further, the second control device may delay the display start time of the second information image when a blinker of the vehicle is in a turn-on state, compared with a case where the blinker is in a turn-off state.

Alternatively, the second control device may determine a degree of a driving load affecting the driver according to a body condition signal of the driver. The second control device delays the display start time of the second information image when the second control device determines that the degree of the driving load is equal to or higher than a predetermined threshold degree, compared with a case where the degree of the driving load is smaller than the predetermined threshold degree.

Alternatively, the second control device may control the display device to switch to display from the first information image to the second information image when a visual contact time of the driver exceeds a predetermined threshold time. The visual contact time is a time interval, for which the driver watches the display device. Further, the second control device may change the predetermined threshold time according to the driving condition of the vehicle. Furthermore, the second control device may delay the display start time of the second information image by increasing the predetermined threshold time when the driving condition is in a high driving load state, compared with a case where the driving condition is not in the high driving load state. The high driving load state is preliminary set as a state that provides a high driving load to the driver. Further, the second control device may control the display device to switch to display from the first information image to the second information image when a total time of the visual contact time of the driver exceeds the predetermined threshold time even in a case where the driving condition is not in a high driving load state, and the high driving load state is preliminary set as a state that provides a high driving load to the driver.

Alternatively, the first information image may show simplified information of the specific event, and the second information image may show detailed information of the specific event.

Alternatively, the first information image may show an image for notifying an occurrence of the specific event to the driver, and the second information image may show an image for inquiring a handling strategy of the specific event or notifying a handling strategy proposal.

Alternatively, the second information image may be an emphasized image of specific information item, which is shown in the first information image.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A control system for controlling a display device mounted on a vehicle, the control system comprising:
a first control device for controlling the display device to display a first information image corresponding to a specific event when the specific event occurs; and
a second control device for controlling the display device to display a second information image corresponding to the specific event after the display device displays the first information image,
wherein the second control device changes a display start time of the second information image according to at least one of a driving condition of the vehicle and a driver condition of a driver of the vehicle.

2. The control system according to claim 1,
wherein the second control device delays the display start time of the second information image when the driving condition is in a high driving load state, compared with a case where the driving condition is not in the high driving load state, and
wherein the high driving load state is preliminary set as a state that provides a high driving load to the driver.

3. The control system according to claim 2,
wherein the second control device delays the display start time of the second information image when the driver drives the vehicle in reverse, compared with a case where the driver does not drive the vehicle in reverse.

4. The control system according to claim 2,
wherein the second control device delays the display start time of the second information image when a steering operation amount of the vehicle is equal to or larger than a predetermined threshold amount, compared with a case where the steering operation amount of the vehicle is smaller than the predetermined threshold amount.

5. The control system according to claim 2,
wherein the second control device delays the display start time of the second information image when a blinker of the vehicle is in a turn-on state, compared with a case where the blinker is in a turn-off state.

6. The control system according to claim 1,
wherein the second control device determines a degree of a driving load affecting the driver according to a body condition signal of the driver, and
wherein the second control device delays the display start time of the second information image when the second control device determines that the degree of the driving load is equal to or higher than a predetermined threshold degree, compared with a case where the degree of the driving load is smaller than the predetermined threshold degree.

7. The control system according to claim 1,
wherein the second control device controls the display device to switch to display from the first information image to the second information image when a visual contact time of the driver exceeds a predetermined threshold time, and
wherein the visual contact time is a time interval, for which the driver watches the display device.

8. The control system according to claim 7,
wherein the second control device changes the predetermined threshold time according to the driving condition of the vehicle.

9. The control system according to claim 8,
wherein the second control device delays the display start time of the second information image by increasing the predetermined threshold time when the driving condition is in a high driving load state, compared with a case where the driving condition is not in the high driving load state, and
wherein the high driving load state is preliminary set as a state that provides a high driving load to the driver.

10. The control system according to claim 7,
wherein the second control device controls the display device to switch to display from the first information image to the second information image when a total time of the visual contact time of the driver exceeds the predetermined threshold time even in a case where the driving condition is not in a high driving load state, and
wherein the high driving load state is preliminary set as a state that provides a high driving load to the driver.

11. The control system according to claim 1,
wherein the first information image shows simplified information of the specific event, and
wherein the second information image shows detailed information of the specific event.

12. The control system according to claim 1,
wherein the first information image shows an image for notifying an occurrence of the specific event to the driver, and
wherein the second information image shows an image for inquiring a handling strategy of the specific event or notifying a handling strategy proposal.

13. The control system according to claim 1,
wherein the second information image is an emphasized image of specific information item, which is shown in the first information image.
